(19) United States
(12) Patent Application Publication
(10) Pub. No.: US 2026/0359070 A1
(43) Pub. Date: Nov. 12, 2026

(54) INFORMATION PROCESSING DEVICE, INFORMATION PROCESSING METHOD AND INFORMATION PROCESSING PROGRAM

(71) Applicant: NTT, INC., Tokyo (JP)

(72) Inventors: Ryota SATO, Musashino-shi, Tokyo (JP); Yoshiaki NAKAJIMA, Musashino-shi, Tokyo (JP); Hiroyoshi TAKIGUCHI, Musashino-shi, Tokyo (JP)

(73) Assignee: NIPPON TELEGRAPH AND TELEPHONE CORPORATION, Tokyo (JP)

(21) Appl. No.: 19/123,945

(22) PCT Filed: Nov. 14, 2022
(86) PCT No.: PCT/JP2022/042298

§ 371 Date: Apr. 24, 2025

(51) Int. Cl. G06F 9/445; G06F 16/28; G06F 16/951

(52) U.S. Cl. CPC G06F 9/44505; G06F 16/284; G06F 16/951

(57) ABSTRACT

An information acquisition unit acquires partial configuration information indicating a partial component of a device. A component estimation unit estimates a new component other than a partial component among the components on the basis of information on a dependence relationship related to the components included in the device and the partial configuration information. A configuration information generation unit adds the new component estimated by the component estimation unit to the partial component of the device to generate complemented configuration information of the device.

### TECHNICAL FIELD

The present invention relates to an information processing apparatus, an information processing method, and an information processing program.

### BACKGROUND ART

While the digital transformation of society and industry is accelerating, the procurement and operation of devices and systems constituting information communication infrastructure is attracting attention. Hereinafter, both devices and systems are simply referred to as a “device”. Hardware components and software components constituting a device are provided from various business operators constituting a supply chain of devices. Therefore, since users may not be able to obtain sufficient information for performing various operations such as management, monitoring, and inspection of devices, it is difficult to cope with risks such as license confirmation and response to vulnerabilities.

Therefore, the configuration information of a device is shared among business operators constituting a supply chain of the device, and efforts to utilize this to deal with risks are progressing. For example, examples of a technology for sharing configuration information include Software Bill Of Materials (SBOM) in which all software components included in a specific information device are listed.

### CITATION LIST

### Non Patent Literature

[NPL 1] “The Minimum Elements For a Software Bill Of Materials [SBOM]”, [online], Jul. 12, 2021, The United States Department of Commerce, [Retrieved Oct. 20, 2022], Internet <URL: https://www.ntia.doc.gov/files/ntia/publications/sbom_minimum_elements_report.pdf>

### SUMMARY OF INVENTION

### Technical Problem

In an existing technology, the provision of the configuration information of a device from a provider to a user is performed on the assumption that each component is open source or the like and the entire configuration is disclosed. However, since the configuration information often includes confidential information for a provider such as unique ingenuity in a system that provides the configuration information, it is difficult for the provider to provide all pieces of configuration information due to the concern of leakage of the confidential information. Further, since the granularity of the configuration information required by the user and the use of the information are not known in advance, the provider is highly likely to provide minimum configuration information even if the provider provides the configuration information. Therefore, in information providing technology of the related art, it is difficult for the user to get required information on the basis of information that can be provided by the provider, and it is difficult to operate the device in a wide range and in an efficient manner.

The present invention has been made in view of the above-described problems, and an object thereof is to enable a device to be operated in a wide range and in an efficient manner.

### Solution to Problem

In order to solve the above problem and achieve the object, an information acquisition unit acquires partial configuration information indicating a part of components of the predetermined device. A component estimation unit estimates a new component other than the partial component among the components on the basis of information on a dependence relationship related to the components included in the predetermined device and the partial configuration information. A configuration information generation unit adds the new component estimated by the component estimation unit to the partial component of the predetermined device to generate complemented configuration information of the predetermined device.

### Advantageous Effects of Invention

According to the present invention, it is possible to operate the device in a wide range and in an efficient manner.

### BRIEF DESCRIPTION OF DRAWINGS

FIG. 1 is a block diagram illustrating an example of a configuration of an information processing apparatus.

FIG. 2 is a flowchart of configuration information generation processing in the information processing apparatus according to a first embodiment.

FIG. 3 is a block diagram illustrating another example of the information processing apparatus.

FIG. 4 is a flowchart of configuration information generation processing in an information processing apparatus according to a fourth embodiment.

FIG. 5 is a diagram illustrating an example of a computer that executes an information processing program.

### DESCRIPTION OF EMBODIMENTS

Hereinafter, an embodiment of an information processing apparatus, an information processing method, and an information processing program disclosed in the present application will be described in detail with reference to the drawings. The information processing apparatus, the information processing method, and the information processing program disclosed in the present application are not intended to be limited by the following embodiments.

### First Embodiment

### <Configuration of Information Processing Apparatus>

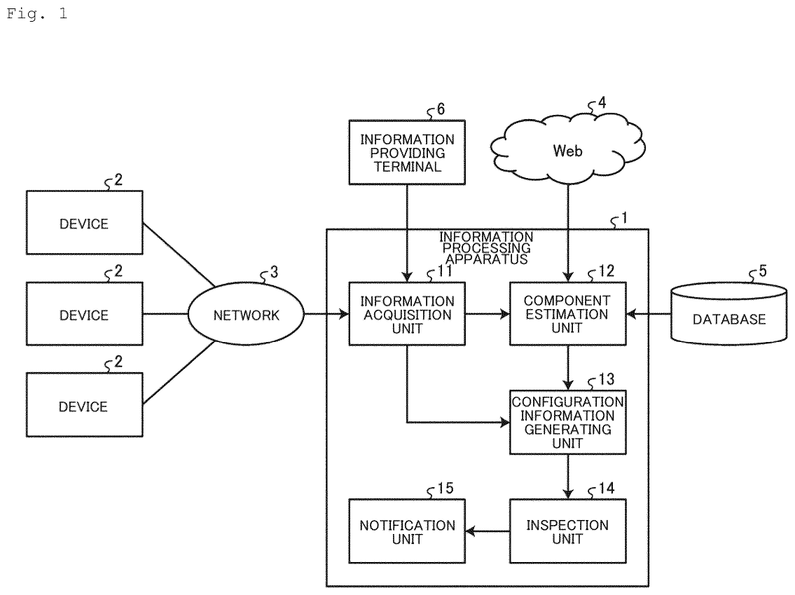

FIG. 1 is a diagram illustrating an example of an information processing apparatus. The information processing apparatus 1 estimates a new component included in the device or system from a dependence relationship between the components on the basis of information on the partial components available from the provider of the device or system. The information processing apparatus 1 generates information indicating the component of the device or system by adding the estimated new component to the partial component and complementing the component.

Here, the component is a component included in a device or a system for realizing their functions, and includes both a hardware component and a software component. Further, the configuration information is the information describing the component of the device or system. For example, the configuration information includes a model number or a serial number of a product as information of a hardware component. The configuration information includes a package name, a file name, attribute information associated therewith, and the like as information of the software component. The information of the software component is, for example, information obtained from data of a package management system of an Operating System (OS), an SBOM, and the like.

As illustrated in FIG. 1, the information processing apparatus 1 may be connected to a plurality of devices 2 via a network 3. The device 2 is a device that is a target of the investigation of the component. The device 2 may be, for example, an information processing apparatus such as a computer such as a client apparatus or a server apparatus, or a communication device. However, the information processing apparatus 1 may not be connected to the device 2 when the information of the component is directly not acquired from the device 2 or the operation of the device 2 may not be observed.

Here, the information processing apparatus 1 can generate configuration information similarly even in a single device 2 or a system configured of a plurality of devices 2.

Hereinafter, the generation of the configuration information for the specific device 2 will be described as an example on the assumption that the system is also included in the device.

The information processing apparatus 1 is connected to a Web 4, a database 5, and an information providing terminal 6. The network 3 may be a Web 4. Further, the database 5 and the information providing terminal 6 may be connected via the network 3, Web 4 or the like, or may be directly connected to the information processing apparatus 1.

As illustrated in FIG. 1, the information processing apparatus 1 includes an information acquisition unit 11, the component estimation unit 12, the configuration information generation unit 13, an inspection unit 14, and the notification unit 15. Hereinafter, a configuration of the information processing apparatus 1 according to the first embodiment will be described with reference to FIG. 1.

The information acquisition unit 11 acquires partial configuration information including information on partial components among all components of the device 2. The partial configuration information is information permitted to be disclosed by the provider of the device 2, and information not permitted to be provided by the provider such as confidential information of the device 2 among all components of the device 2 is not included. The partial configuration information includes, for example, a component name of a hardware component, a software name of a software component, and the like present in the device 2 as components.

The information acquisition unit 11 may acquire, for example, information on the components of the device 2 transmitted using the information providing terminal 6 by the provider of the device 2. Further, the information acquisition unit 11 may acquire information on components that can be acquired by the device 2 via the network 3. Alternatively, the information acquisition unit 11 may acquire the information on components provided by the user of the information processing apparatus 1 from the provider of the device 2, through an input using an input device (not shown) by the user. The information acquisition unit 11 can collectively use the information of the components of the device 2 acquired by the various means described above as the partial configuration information.

Then, the information acquisition unit 11 outputs the acquired partial configuration information to the component estimation unit 12 and the configuration information generation unit 13.

The component estimation unit 12 receives input of partial configuration information of the device 2 from the information acquisition unit 11. Next, the component estimation unit 12 estimates a new component on the basis of the dependence relationship between the components of the device 2 and the partial configuration information. The component estimation unit 12 estimates new components other than components included in the partial configuration information having a dependence relationship with each component by using public information such as information on a Web 4 which can be browsed by an unspecified person, which is generally disclosed, for each component included in the partial configuration information. When there are a plurality of new components to be estimated, the component estimation unit 12 collects all the components. The dependence relationship between the components corresponds to an example of the “dependence relationship related to the components”.

For example, the component estimation unit 12 performs crawling or keyword extraction on an open source on the web on the basis of the software name included in the partial configuration information. The component estimation unit 12 specifies a library having a dependence relationship with the software name, that is, a library used for operation of the software having the software name, and collects the library name. In this case, the dependence relationship between the software and the library corresponds to an example of the dependence relationship between the components.

For example, in the case of crawling and keyword extraction of a web site, the component estimation unit 12 extracts a web site including a software name, by utilizing “Requests”, “Beautiful Soup”, “Scrapy” or the like when a language used is Python (registered trademark). The component estimation unit 12 collects library names by automatically extracting a character string associated with a word called a library from the extracted Web site.

Alternatively, the component estimation unit 12 may utilize a database providing a dependence relationship of an Open Source Software (OSS) library to automatically extract a library related to a software name which is a component of the device 2, and collect the library name. The component estimation unit 12 can use, for example, “Open Source Insights Project” provided by Google (Registered trademark) as a database for providing the dependence relationship of the library of the OSS.

Thereafter, the component estimation unit 12 estimates that the specified new component exists in the device 2 as a component, and outputs information on the collected new component to the configuration information generation unit 13. For example, when library names having a dependence relationship with the software names are collected, the component estimation unit 12 estimates that the library having the library name is present as the component in the device 2, and outputs the collected library name to the configuration information generation unit 13.

The configuration information generation unit 13 receives the input of the partial configuration information provided from the provider of the device 2 from the information acquisition unit 11. Further, the configuration information generation unit 13 receives input of information on the new component estimated as the component in the device 2 from the component estimation unit 12. The configuration information generation unit 13 adds the information on the new component to the partial configuration information to complement the component of the device 2, thereby generating complemented configuration information indicating the component of the device 2. Here, the configuration information generated by the configuration information generation unit 13 does not include all the components of the device 2 in some cases, and is referred to as “complemented configuration information”. Thereafter, the configuration information generation unit 13 outputs the complemented configuration information to the inspection unit 14.

The inspection unit 14 receives the input of the complementary configuration information of the device 2 from the configuration information generation unit 13. The inspection unit 14 inspects a state of the device 2 such as the determination of the vulnerability of the device 2 or the detection of the presence of an unintended file by using the complemented configuration information.

For example, the inspection unit 14 can execute a management task such as configuration management, monitoring, or inspection of the device 2 to be illustrated below, by using the complemented configuration information. For example, the inspection unit 14 can perform collation with an entity list through configuration management of the software components and hardware components included in the device 2 by using the complemented configuration information. The inspection unit 14 can perform alteration monitoring as to whether or not the unintended file is included in the device 2 by using the complemented configuration information. Further, the inspection unit 14 can also be used for vulnerability inspection related to software components included in the device 2 by using the complemented configuration information.

The inspection unit 14 according to the present embodiment determines whether or not there is a vulnerability of the device 2. For example, the inspection unit 14 collates a software name listed in a disclosed vulnerability database such as a National Vulnerability Database (NVD) with a software name included in the configuration information. When the software name is detected, the inspection unit 14 confirms whether or not the presence or absence of vulnerability related to the library included in the configuration information is registered in the information related to the software.

Thereafter, the inspection unit 14 outputs an inspection result related to the device 2 to the notification unit 15. For example, the inspection unit 14 outputs information on the vulnerability of the library used by the device 2 to the notification unit 15 when there is a vulnerability.

The notification unit 15 receives the input of the inspection result of the device 2, from the inspection unit 14. The notification unit 15 notifies the user of a result of the inspection related to the device 2 by displaying the result of the inspection on a display device (not shown). The notification unit 15 may transmit the result of the inspection, for example, to a terminal apparatus of the user via a Web 4 or the like.

Here, a case where the notification unit 15 notifies the user of the presence of the vulnerability of a specific library will be described. When vulnerability with high urgency of the specific library is disclosed, the user has missed the vulnerability because the configuration information from the provider does not include information of the library in the related art. On the other hand, the information processing apparatus 1 notifies the user of the presence of the vulnerability of the specific library, so that the user can inquire of the provider about an influence of the vulnerability of the specific library.

### Configuration Information Generation Processing

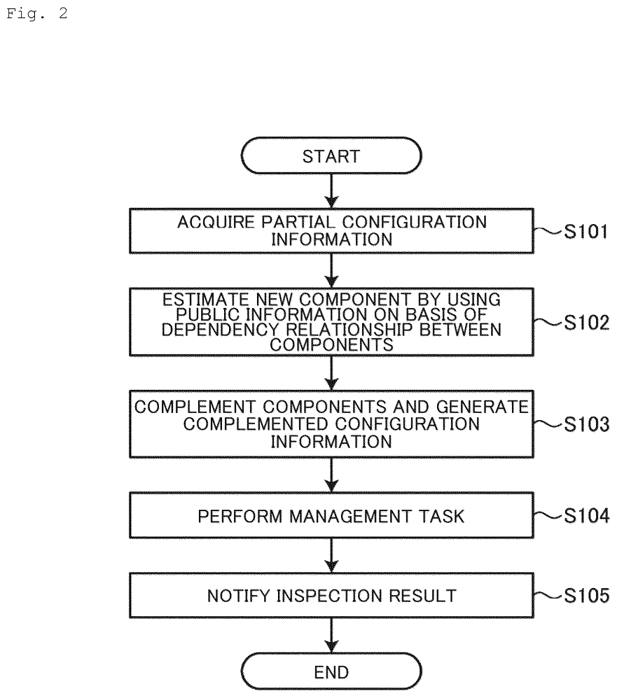

FIG. 2 is a flowchart of configuration information generation processing in the information processing apparatus according to the first embodiment. Next, a flow of the configuration information generation processing of the information processing apparatus 1 according to the present embodiment will be described with reference to FIG. 2.

The information acquisition unit 11 acquires partial configuration information that is information on a partial component among all components of the device 2 (step S101).

The component estimation unit 12 acquires the partial configuration information provided from the provider of the device 2, from the information acquisition unit 11. The component estimation unit 12 estimates the new component of the device 2 having the dependence relationship with the component included in the partial configuration information by using the public information such as the information on the Web 4 on the basis of the dependence relationship between the Components (step S102).

The configuration information generation unit 13 receives the input of the partial configuration information provided from the provider of the device 2, from the information acquisition unit 11. The configuration information generation unit 13 receives input of information on the new component estimated as the component in the device 2 from the component estimation unit 12. The configuration information generation unit 13 adds the information on the new component to the partial configuration information to complement the component of the device 2, and generates complemented configuration information on the device 2 (step S103).

The inspection unit 14 acquires the complemented configuration information from the configuration information generation unit 13. The inspection unit 14 performs a management task such as configuration management, monitoring or inspection of the device 2 by using the complemented configuration information (step S104). For example, the inspection unit 14 performs inspection for determining the presence or absence of the vulnerability of the device 2 by using the complemented configuration information.

The notification unit 15 receives an input of an inspection result related to the vulnerability of the device 2 from the inspection unit 14. The notification unit 15 notifies the user of the inspection result related to the vulnerability of the device 2 by displaying the inspection result on a display device (not shown) (step S105).

### Effects of Information Processing Apparatus and Configuration Information Generation Processing

As described above, the information processing apparatus 1 according to the present embodiment acquires the partial configuration information from the provider of the device or the system, and estimates the new component included in the device or the system from the dependence relationship between the components. The information processing apparatus 1 adds the estimated new component to the partial component provided from the provider of the device or the system, and complements the component, thereby generating complemented configuration information of the device or the system.

Thus, the user of the device or the system can complement the element of the related configuration information from information available by the user even in a situation where sufficient configuration information cannot be obtained from the provider, and can perform operations such as management, monitoring, or inspection of the device or system more widely and efficiently.

Further, the provider of the device or system may not disclose confidential information such as unique ingenuity in the device or system for efficient operation by the user of the device or system to be provided. On the other hand, when there is an abnormality (for example, vulnerability in an OSS) in components of a non-disclosed part, and the provider is not able to recognize or find the abnormality, inquiries or complaints from users can lead to early action by the provider of the device or system.

### Second Embodiment

Next, a second embodiment will be described. The information processing apparatus 1 according to the present embodiment is also shown in the block diagram of FIG. 1. The information processing apparatus 1 according to the present embodiment retrieves the database 5 in which the dependence relationship between the components that has been created in advance has been collected, and collects and holds information on new components. Hereinafter, the information processing apparatus 1 according to the present embodiment will be described in detail. In the following description, operations of the respective units similar to those in the first embodiment will be omitted.

The database 5 according to the present embodiment collects and holds information on the dependence relationship between the components of the device 2 created in advance. Specifically, the database 5 collects and holds information on a dependence relationship of the software and the library created from the viewpoint of the dependence relationship of the library and the software used for the operation of the software which is a component of the device 2. The information on the dependence relationship between the software and the library is indicated by, for example, a software name and a library name.

For example, the database 5 is constructed by separately preparing a device into which a popular OS or software is introduced in advance and collecting information on the dependence relationship between the components by using the prepared device. More specifically, in the case of a device in which Linux (registered trademark) is introduced, a set of an OS, software name, or version information and a dependent library is made into a database by retrieving the dependent library utilizing commands such as “ldd” or “readelf -d”. With such a scheme, the database 5 for holding the information on the dependence relationship between the software and the library is constructed.

The component estimation unit 12 receives input of the partial configuration information provided from the provider of the device 2 from the information acquisition unit 11. Next, the component estimation unit 12 specifies a library having a dependence relationship with the software by using the information on the dependence relationship between the software and the library which the database 5 has for each component included in the partial configuration information. The component estimation unit 12 collects the library name of the specified library as the information on the new component.

Thereafter, the component estimation unit 12 estimates that a library having a library name as a new component exists in the device 2 as a component, and outputs the collected library name to the configuration information generation unit 13. Thus, the information processing apparatus 1 can complement the partial configuration information of the device 2 with the library name as the component, and can generate the complemented configuration information of the device 2.

As described above, the information processing apparatus 1 according to the present embodiment registers the information on the dependence relationship between the software and the library in the database 5 in advance, and specifies the library as a new component by using the database 5. Thus, even when the database 5 having information on the dependence relationship between the components such as the dependence relationship between the software and the library is used, the information processing apparatus 1 can complement the library as a new component by adding the library to the partial component provided by the provider. Therefore, the user of the device or the system can complement the library related to the software as a component from the information available by the user even in a situation where sufficient configuration information cannot be obtained from the provider. Thus, the user can perform operations such as management, monitoring, or inspection of the device or system more widely and efficiently.

### Third Embodiment

Next, a third embodiment will be described. The information processing apparatus 1 according to the present embodiment is also shown in the block diagram of FIG. 1. The information processing apparatus 1 according to the present embodiment holds the database 5 that holds information on a dependence relationship between software and a file created in advance from the viewpoint of a file held for execution of the software, retrieves the database 5, and collects information on new components. Hereinafter, the information processing apparatus 1 according to the present embodiment will be described in detail. In the following description, operations of the respective units similar to those in the first embodiment will be omitted.

The database 5 according to the present embodiment holds the following information as information of the dependence relationship between the components of the device 2 which has been created in advance. Specifically, the database 5 collects and holds the information on the dependence relationship of the software and the file created from the viewpoint of the dependence relationship of the file and the software, which is held for execution of the software which is the component of the device 2. The information on the dependence relationship between the software and the file is indicated by, for example, a software name and a file name.

For example, the database is constructed by separately preparing a device into which a popular OS or software is introduced in advance and acquiring a file name of each file included in a file group constituting each software from the prepared device. Thus, the database 5 that holds information on the dependence relationship between the software and the file is constructed.

Further, for a file group constituting specific software from a directory, extension, property information, or the like, files that do not change in any environment and files that change can be selected in the case of the same software. Therefore, the database 5 may acquire a hash value or the like for a file which does not change and hold the hash value as information of a file having a dependence relationship with the software.

The component estimation unit 12 receives the input of the partial configuration information provided from the provider of the device 2 from the information acquisition unit 11. Then, the component estimation unit 12 retrieves information on the dependence relationship between the software and the file held in the database 5 by using the software name included in the partial configuration information. The component estimation unit 12 collects file names of files having dependence relationship with the software. Thereafter, the component estimation unit 12 estimates that the file having the file name is present as the component in the device 2, and outputs the collected file name to the configuration information generation unit 13. Thus, the information processing apparatus 1 can complement the partial configuration information of the device 2 with the file name as the component, and can generate the complemented configuration information of the device 2.

As described above, the information processing apparatus 1 according to the present embodiment registers the information on the dependence relationship between software and files in the database 5 in advance, and specifies the file as a new component by using the database 5. Thus, even when the database 5 having information indicating the dependence relationship between the software and the file is used, the information processing apparatus 1 can complement the partial components provided by the provider by adding the file name as the estimated new component. Therefore, the user of the device or the system can complement a file related to the software as the component from the information available by the user even in a situation where sufficient configuration information cannot be obtained from the provider. Thus, the user can perform operations such as management, monitoring, or inspection of the device or system more widely and efficiently.

### Fourth Embodiment

### <Configuration of Information Processing Apparatus>

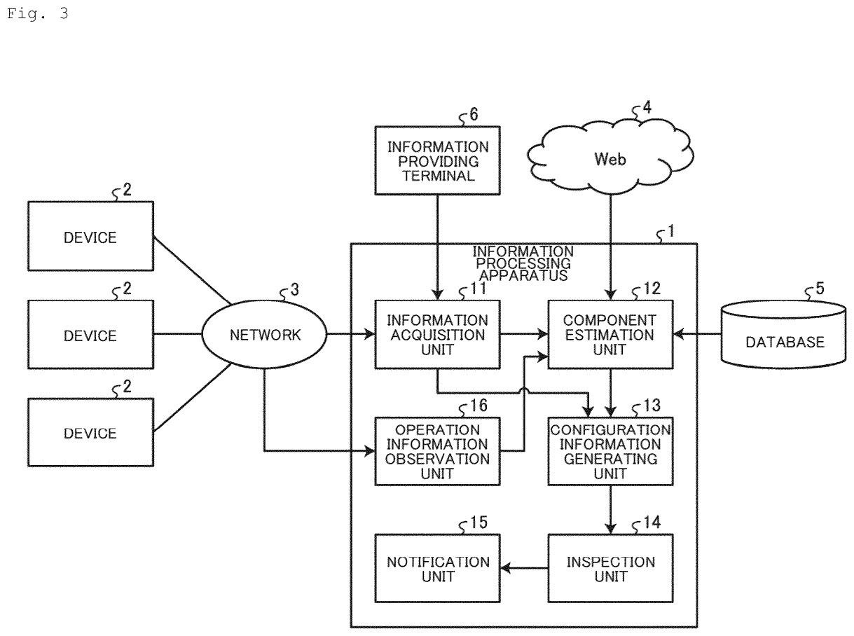

FIG. 3 is a diagram illustrating another example of the information processing apparatus. Hereinafter, the information processing apparatus 1 according to the present embodiment will be described with reference to FIG. 3.

The information processing apparatus 1 according to the present embodiment acquires operation information obtained by operating the device 2. Next, the information processing apparatus 1 specifies a characteristic of the operation of the device 2 from the acquired operation information. Here, the characteristic of the operation of the device 2 is information on resources used when communication or various processing is executed, and is information related to components of the device 2. The information processing apparatus 1 estimates the new component included in the device or the system by using a dependence relationship between the characteristic of the operation of the device 2 and the component. The information processing apparatus 1 generates the information indicating the component of the device or system by adding the estimated new component to the partial component and complementing component.

As illustrated in FIG. 3, the information processing apparatus 1 includes the information acquisition unit 11, the component estimation unit 12, the configuration information generation unit 13, the inspection unit 14, the notification unit 15, and an operation information observation unit 16. Hereinafter, the information processing apparatus 1 according to the present embodiment will be described in detail. In the following description, operations of the respective units similar to those in the first embodiment will be omitted.

When the user of the device 2 operates the device 2, the operation information observation unit 16 captures a communication log as an operation information of the device 2. When the operation log can be directly confirmed or when the operation log can be remotely confirmed by utilizing a log management system such as rsyslog, the operation information observation unit 16 may also acquire the information as the operation information. Hereinafter, a case where the operation information observation unit 16 acquires the communication log as the operation information will be described as an example. The operation information observation unit 16 outputs the acquired communication log of the device 2 to the component estimation unit 12.

The component estimation unit 12 receives input of the communication log of the device 2 from the operation information observation unit 16. Next, the component estimation unit 12 acquires information used for communication processing by the device 2, which is one of a protocol name, a port number, and communication content included in an Internet Protocol (IP) header or an IP payload, or a combination thereof, as the characteristic of the operation of the device 2 from the acquired communication log.

Next, the component estimation unit 12 specifies and collects new components other than components included in the partial configuration information having a dependence relationship with the characteristic of the operation of the device 2 by using the public information such as the information on the Web 4 which can be browsed by an unspecified person, for the acquired characteristic of the operation of the device 2. The dependence relationship between the characteristics of the operation of the device 2 and the components corresponds to an example of the “dependence relationship related to the components”.

For example, the component estimation unit 12 crawls an open source such as information on the Web 4 by using a protocol name and a port number which are the characteristics of the operation of the device 2. Thus, the component estimation unit 12 collects the software name using the acquired protocol name and port number from the viewpoint of dependence relationship between the characteristic of operation, such as the protocol name and port number, and the component.

For example, the component estimation unit 12 acquires information that a Hypertext Transfer Protocol (HTTP) protocol and a port numbered 80 are used as a characteristic of the operation of the device 2. Then, the component estimation unit 12 confirms that a web server application is installed in the device 2 from the open source. For example, the component estimation unit 12 can use a Well known ports managed by the Internet Assigned Numbers Authority (IANA) as an open source. Further, the component estimation unit 12 crawls the open source with the web server application as an input. The component estimation unit 12 estimates applications which are assumed to be used, such as “Apache”, “Nginx”, “IIS (Internet Information Services) ”, and extracts application names thereof.

In addition, when there is OS information among the components included in the partial configuration information available from the provider, the component estimation unit 12 can narrow down the application name from the applications assumed to be used. For example, when the OS is Windows, the component estimation unit 12 can narrow down the web server application to “IIS”. When information of a Graphic User Interface (GUI) is obtained from the device 2 as the operation information, the component estimation unit 12 can also acquire the OS information from the characteristic of the GUI. For example, the component estimation unit 12 can perform image recognition on the obtained GUI, and determine that the OS operating in the device 2 is Windows or the like. When the HTTP header can be confirmed, the component estimation unit 12 can acquire the type or version of the web server application from a server tag.

In addition, the following cases exist as the estimation of new components. For example, when the device 2 uses a port numbered 8080, the component estimation unit 12 can estimate that a web servlet container application such as tomcat, Jetty, or Jboss is operating on the device 2. Further, the component estimation unit 12 can estimate the presence of Remote SH when the device 2 uses port numbered 514, and can estimate the presence of various applications such as Secure Shell (ssh) when the device 2 uses a port numbered 22.

Further, in an environment where access to the device 2 is permitted, the component estimation unit 12 can confirm the component of the device 2 by using various commands. For example, the component estimation unit 12 can perform confirmation of, for example, a type of a server application using a “wget -S” command, confirmation of a version of BIND used in a DNS server using a “dig version.bind” command, or the like.

Thereafter, the component estimation unit 12 outputs the information on the new component having a dependence relationship with the characteristic of the operation of the device 2 to the configuration information generation unit 13. Thus, the information processing apparatus 1 can complement the partial configuration information of the device 2 by using the new component having the dependence relationship with the characteristic of the operation of the device 2, and can generate the complemented configuration information of the device 2.

### Configuration Information Generation Processing

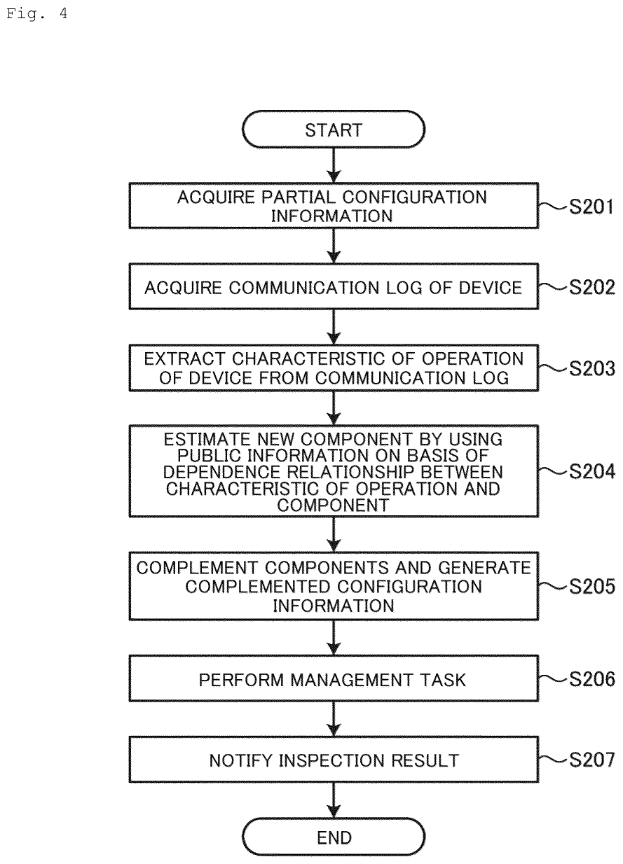

FIG. 4 is a flowchart of configuration information generation processing in an information processing apparatus according to a fourth embodiment. Next, a flow of configuration information generation processing of the information processing apparatus 1 according to the present embodiment will be described with reference to FIG. 4.

The information acquisition unit 11 acquires partial configuration information that is information on a partial component among all components of the device 2 (step S201).

When the user of the device 2 operates the device 2, the operation information observation unit 16 acquires a communication log as the operation information of the device 2 (step S202).

The component estimation unit 12 acquires the operation information of the device 2 from the operation information observation unit 16. The component estimation unit 12 may acquire the partial configuration information provided from the provider of the device 2, from the information acquisition unit 11. Next, the component estimation unit 12 extracts the characteristic of the operation of the device 2 from the operation information (step S203).

The component estimation unit 12 estimates a new component of the device 2 by using the public information such as the information on the Web 4 on the basis of the dependence relationship between the characteristic of the operation of the device 2 and the component (step S204).

The configuration information generation unit 13 receives the input of the partial configuration information provided from the provider of the device 2 from the information acquisition unit 11. The configuration information generation unit 13 receives input of information on the new component estimated as the component in the device 2 from the component estimation unit 12. The configuration information generation unit 13 adds the information on the new component to the partial configuration information to complement the component of the device 2, and generates the complemented configuration information indicating the component of the device 2 (step S205).

The inspection unit 14 acquires the complemented configuration information from the configuration information generation unit 13. The inspection unit 14 performs a management task such as configuration management, monitoring or inspection of the device 2 by using the complemented configuration information (step S206). For example, the inspection unit 14 performs inspection for determining the presence or absence of the vulnerability of the device 2 by using the complemented configuration information.

The notification unit 15 receives an input of an inspection result related to the vulnerability of the device 2 from the inspection unit 14. The notification unit 15 notifies the user of the inspection result related to the vulnerability of the device 2 by displaying the inspection result on a display device (not shown) (step S207).

As described above, the information processing apparatus 1 according to the present embodiment collects operation information of the device or system, and acquires characteristics of the operation of the device or system from the collected operation information. The information processing apparatus 1 estimates a new component having a dependence relationship with the acquired characteristics of the operation of the device or system. Thus, the information processing apparatus 1 can add the new component estimated from the dependence relationship between the characteristic of the operation and the component to the partial component provided by the provider, and complement the component.

Therefore, the user of the device or system can complement an element of the related configuration information from information on an available characteristic of the operation even in a situation where sufficient configuration information cannot be obtained from the provider, and can perform operations such as management, monitoring, or inspection of the device or system more widely and efficiently.

### Fifth Embodiment

Next, a fifth embodiment will be described. The information processing apparatus 1 according to the present embodiment is also shown in the block diagram of FIG. 3. The information processing apparatus 1 according to the present embodiment retrieves the database 5 in which the dependence relationship between the characteristic of the operation of the device 2 and the component that has been created in advance has been collected, to collect and hold information on new components. Hereinafter, the information processing apparatus 1 according to the present embodiment will be described in detail. In the following description, operations of the respective units similar to those in the fourth embodiment will be omitted.

The database 5 according to the present embodiment holds the following information as information on the dependence relationship between the characteristic of the operation of the device 2 and the component created in advance. Specifically, the database 5 collects and holds information on a dependence relationship between the software and the communication pattern, which is created from the viewpoint of a dependence relationship between the communication patterns of various types of software and the software.

For example, the database 5 is constructed by separately preparing a device into which a popular OS or software is introduced in advance, and acquiring a communication pattern when specific software is operated by using the prepared device to make the communication pattern into a database. For the acquisition of the communication pattern, for example, machine learning can be used. (See “https://arakawa-lab.com/wp-content/uploads/2022/01/p933_5G-2.pdf, Study on a scheme of estimating an activation function of IoT devices based on communication traffic analysis. Multimedia, Distribution, Cooperation, and Mobile (DICOMO2020) Symposium, 2020.”)

The component estimation unit 12 receives input of the communication log of the device 2 from the operation information observation unit 16. Next, the component estimation unit 12 extracts, from the acquired communication log, a protocol, a frequency, an amount, and a direction of communication when specific software is started, as the characteristic of the operation of the device 2. The component estimation unit 12 acquires a communication pattern when the specific software is started from the extracted information as the characteristic of the operation of the device 2.

Next, the component estimation unit 12 specifies software having a dependence relationship with the acquired communication pattern by using information on the dependence relationship between the characteristic of the operation of the database 5 and the component for the acquired communication pattern. The component estimation unit 12 collects a software name of the specified software or a file name of a file used in the software as information of the new Component.

Thereafter, the component estimation unit 12 estimates that the estimated software or the file having the collected file name is present as the component in the device 2, and outputs the collected software name or the file name to the configuration information generation unit 13. Thus, the information processing apparatus 1 can complement the partial configuration information of the device 2 with the software name or the file name as the component, and can generate the complemented configuration information of the device 2.

As described above, the information processing apparatus according to the present embodiment previously registers the dependence relationship between the characteristics of the operation of the device or system and the components in the database, and specifies the library as a new component by using the database. Thus, even when the database having the information on the dependence relationship between the characteristics of the operation of the device or system and the component is used, the information processing apparatus can add the estimated new component to the partial component provided by the provider and complement the component. Therefore, the user of the device or the system can estimate and complement the new component from the information available by the user even in a situation where sufficient configuration information cannot be obtained from the provider. Thus, the user can perform operations such as management, monitoring, or inspection of the device or system more widely and efficiently.

### System Configuration and Like

Further, each component of each apparatus shown in the drawings is functionally conceptual, and does not necessarily need to be physically configured as shown in the drawing. That is, specific forms of the distribution and integration of the devices are not limited to those shown in the drawings, and all or some of the forms can be distributed or integrated functionally or physically in any unit in accordance with various loads, usage situations, or the like. Further, all or some of the processing functions performed by the devices may be realized by a Central Processing Unit (CPU) and a program that is analyzed and executed by the CPU, or may be realized as hardware using wired logic.

Further, among the processes described in the present embodiment, all or some of the processes described as being automatically performed can also be manually performed, or all or some of the processes described as being manually performed can also be performed automatically using a known method. In addition, the processing procedure, the control procedure, specific names, information including various types of data and parameters that are shown in the above document and drawings may be arbitrarily changed unless otherwise described.

### Program

As one embodiment, the information processing apparatus 1 can be implemented by installing an information providing program for executing the above-described information processing in a desired computer as package software or online software. For example, the information processing apparatus 1 can be caused to function by causing the information processing apparatus to execute the above-described information processing program. The information processing apparatus 1 mentioned here includes a desktop or a laptop personal computer. In addition, a category of the information processing apparatus 1 includes a mobile communication terminal such as a smartphone, a mobile phone, or a Personal Handy-phone System (PHS), and a slate terminal such as a Personal Digital Assistant (PDA).

Further, the information processing apparatus 1 can also be implemented as a server apparatus that provides services relating to the information processing to a client, with a terminal apparatus that is used by the user as the client. For example, the information processing apparatus 1 is implemented as a server apparatus that provides a service of receiving the information on the device 2 and complementing the component. In this case, the server apparatus may be implemented as a web server or may be implemented as a cloud that provides services related to the information processing through outsourcing.

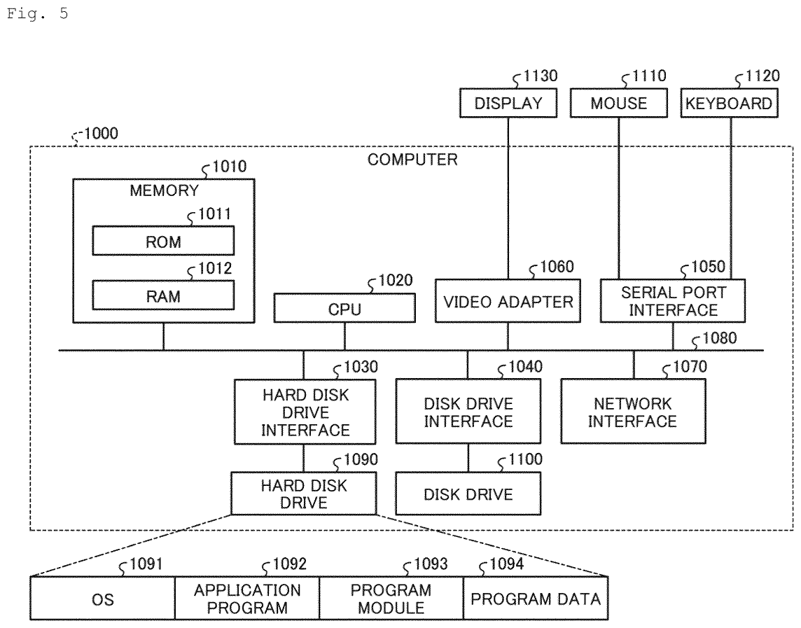

FIG. 5 is a diagram illustrating an example of a computer that executes an information processing program. A computer 1000 includes a memory 1010 and a CPU 1020, for example. Further, the computer 1000 also includes a hard disk drive interface 1030, a disk drive interface 1040, a serial port interface 1050, a video adapter 1060, and a network interface 1070. These units are connected by a bus 1080.

The memory 1010 includes a Read Only Memory (ROM) 1011 and a Random Access Memory (RAM) 1012. The ROM 1011 stores, for example, a boot program, such as a Basic Input Output System (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, an information processing program that defines each processing of the information processing apparatus 1 which has the similar function with the information processing apparatus 1 is implemented as the program module 1093 on which computer-executable codes are described. The program module 1093 is stored in, for example, the hard disk drive 1090. The program module 1093 for executing the same processing as the functional configurations of the information processing apparatus 1, for example, is stored in the hard disk drive 1090. The hard disk drive 1090 may be replaced with a Solid State Drive (SSD).

Furthermore, the setting data used in the processing of the above-described embodiment is stored, for example, in the memory 1010 or the hard disk drive 1090 as the program data 1094. The CPU 1020 reads the program module 1093 or the program data 1094 stored in the memory 1010 or the hard disk drive 1090 into the RAM 1012 as necessary, and executes the processing of the above-described embodiment.

The program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (a Local Area Network (LAN), a Wide Area Network (WAN), or the like). The program module 1093 and the program data 1094 may be read by the CPU 1020 from another computer via the network interface 1070.

### REFERENCE SIGNS LIST

1 Information processing apparatus
2 Device
3 Network
4 Web
11 Information acquisition unit
12 Component estimation unit
13 Configuration information generation unit
14 Inspection unit
15 Notification unit
16 Operation information observation unit

1. An information processing apparatus comprising:
a memory; and
processing circuitry configured to:
acquire partial configuration information indicating a partial component of a predetermined device;
estimate a new component other than the partial component among the components on the basis of information on a dependence relationship related to the components included in the predetermined device and the partial configuration information; and
add the new component estimated to the partial component of the predetermined device to generate complemented configuration information of the predetermined device.

2. The information processing apparatus according to claim 1, wherein
the processing circuitry is further configured to estimate the new component on the basis of a dependence relationship between the components included in the predetermined device.

3. The information processing apparatus according to claim 1, further comprising:
a database configured to collect and hold information on the dependence relationship in advance, wherein
the processing circuitry is further configured to estimate the new component with reference to the database.

4. The information processing apparatus according to claim 1,
wherein
the processing circuitry is further configured to acquire operation information of the predetermined device, wherein
the processing circuitry is further configured to specify a characteristic of an operation of the predetermined device from the operation information acquired, and estimates the new component on the basis of a dependence relationship between the characteristic of the operation and the components included in the predetermined device and the specified characteristic of the operation.

5. The information processing apparatus according to claim 4,
wherein
the processing circuitry is further configured to specify information used for communication processing by the predetermined device as a characteristic of the operation.

6. The information processing apparatus according to claim 1, wherein the processing circuitry is further configured to inspect a state of the predetermined device using the complemented configuration information.

7. An information processing method by an information processing apparatus, comprising:
acquiring partial configuration information indicating a partial component of a predetermined device;
estimating a new component other than the partial component among the components on the basis of information on a dependence relationship related to the components included in the predetermined device and the partial configuration information; and
adding the new component estimated in the component estimation step to the partial component of the predetermined device to generate complemented configuration information of the predetermined device.

8. A non-transitory computer-readable recording medium having stored therein an information processing program causing a computer to execute a process comprising:
acquiring partial configuration information indicating a partial component of a predetermined device;
estimating a new component other than the partial component among the components on the basis of information on a dependence relationship related to the components included in the predetermined device and the partial configuration information; and
adding the new component estimated in the component estimation step to the partial component of the predetermined device to generate complemented configuration information of the predetermined device.
